(19) United States
(12) Patent Application Publication
(10) Pub. No.: US 2006/0100836 A1
(43) Pub. Date: May 11, 2006

(54) Performance forecasting and bit selection tool for drill bits

(76) Inventor: Amardeep Singh, Houston, TX (US)

Correspondence Address: OSHA LIANG L.L.P., 1221 MCKINNEY STREET, SUITE 2800, HOUSTON, TX, 77010, US

(21) Appl. No.: 10/984,950

(22) Filed: Nov. 9, 2004

(51) Int. Cl. G06G 7/48

(52) U.S. Cl. 703/10

(57) ABSTRACT

A method for forecasting performance of a drill bit, that includes obtaining a performance model for the drill bit, using a plurality of bit run records of the drill bit, wherein the obtaining is performed with a multivariate regression, and inputting a set of drilling parameters to the performance model to obtain the performance of the drill bit.

### BACKGROUND OF INVENTION

### BACKGROUND ART

Wellbore drilling, such as that used for petroleum exploration and production, includes rotating a drill bit while applying axial force to the drill bit. The rotation and the axial force are typically provided by equipment which includes a drilling “rig.” The rig includes various devices thereon to lift, rotate and control segments of drill pipe which ultimately connect the drill bit to the equipment on the rig. The drill pipe includes an hydraulic passage generally in its center through which drilling fluid is pumped. The drilling fluid discharges through selected-size orifices in the bit (“jets”) for the purposes of cooling the drill bit and lifting rock cuttings out of the wellbore as it is being drilled.

The speed and economy with which a wellbore is drilled, as well as the quality of the hole drilled, depend on a number of factors. These factors include, among others, the mechanical properties of the rocks which are drilled, the diameter and type of the drill bit used, the flow rate of the drilling fluid, and the rotation speed and axial force applied to the drill bit. It is generally the case that for any particular mechanical properties of rocks, a rate at which the drill bit penetrates the rock (“ROP”) is proportional to the amount of axial force (or weight-on-bit) and the rotary speed of the drill bit. Further, the rate at which the drill bit wears out is generally related to the rate of penetration.

One of the biggest challenges of petroleum exploration has been the fact that it is impossible to know what actually occurs “downhole.” Therefore, it has been a challenge to predict the performance of a drill bit, and, thus, selecting an appropriate tool for drilling a particular formation under particular conditions.

Various methods have been developed for predicting drill bit performance and selecting a type of drill bit for drilling a particular formation. Typically, these methods relate to analysis of data of previously drilled wells, analysis of worn or dull drill bits, or simulation of formation drillability.

### SUMMARY OF INVENTION

In one aspect, the present invention relates to a method for forecasting performance of a drill bit, that includes obtaining a performance model for the drill bit, using a plurality of bit run records of the drill bit, wherein the obtaining is performed with a multivariate regression, and inputting a set of drilling parameters to the performance model to obtain the performance of the drill bit.

Other aspects and advantages of the invention will be apparent from the following description and the appended claims.

### BRIEF DESCRIPTION OF DRAWINGS

FIG. 1 shows bit run records, in accordance with one or more embodiments of the present invention.

FIG. 2 shows a table of variable coefficients, standard errors, and coefficient contribution factors in accordance with one or more embodiments of the present invention.

FIG. 3 shows a tornado graph in accordance with one or more embodiments of the present invention.

FIG. 4 shows a set or residual plots in accordance with one or more embodiments of the present invention.

FIG. 5 shows a flow chart for forecasting performance of a drill bit, in accordance with one or more embodiments of the present invention.

FIG. 6 shows a flow chart for forecasting performance of a drill bit, in accordance with one or more embodiments of the present invention.

FIG. 7 shows a block diagram of a typical computer system.

### DETAILED DESCRIPTION

The present invention relates to methods and apparatus for forecasting the performance of a drill bit and/or selecting a drill bit, using regression models. In general, regression models are used to relate one or more dependent variables to one or more independent variables. In accordance with embodiments of the present invention, which relates specifically to oil and gas exploration, a regression model may be used to relate a drilling performance variable to one or more drilling explanatory variables.

Drilling performance variables may include, for example, rate of penetration, drilling time (or hours spent drilling), and total drilling depth. Drilling explanatory variables may include, for example, weight on bit (WOB), revolutions per minute (RPM), drilling depth, hydraulic horsepower per square inch, mud weight, mud type, rotary type, deviation, and formation type, etc. One of ordinary skill in the art will appreciate that the drilling performance variables and the drilling explanatory variables may include other drilling characteristics.

Generally, data relating to the drilling performance variables and the drilling explanatory variables are collected during drilling operations and stored in a database.

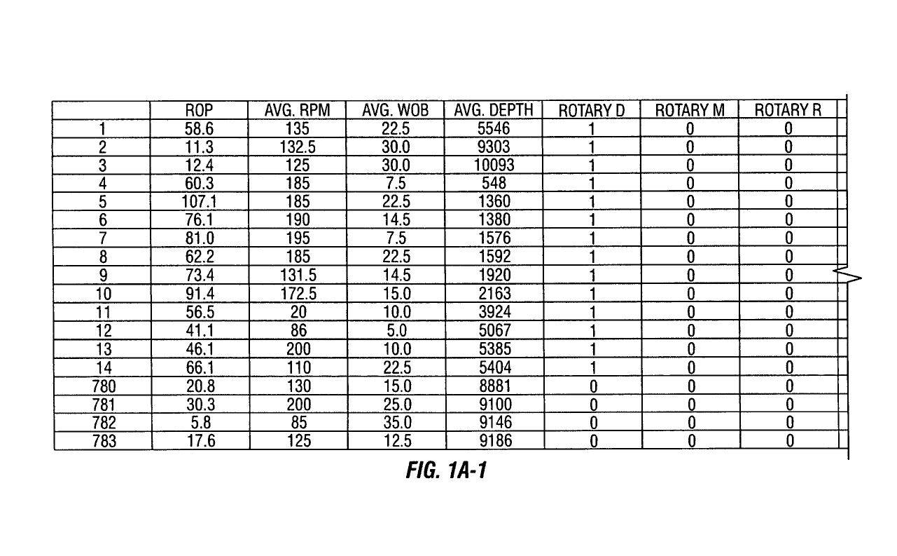

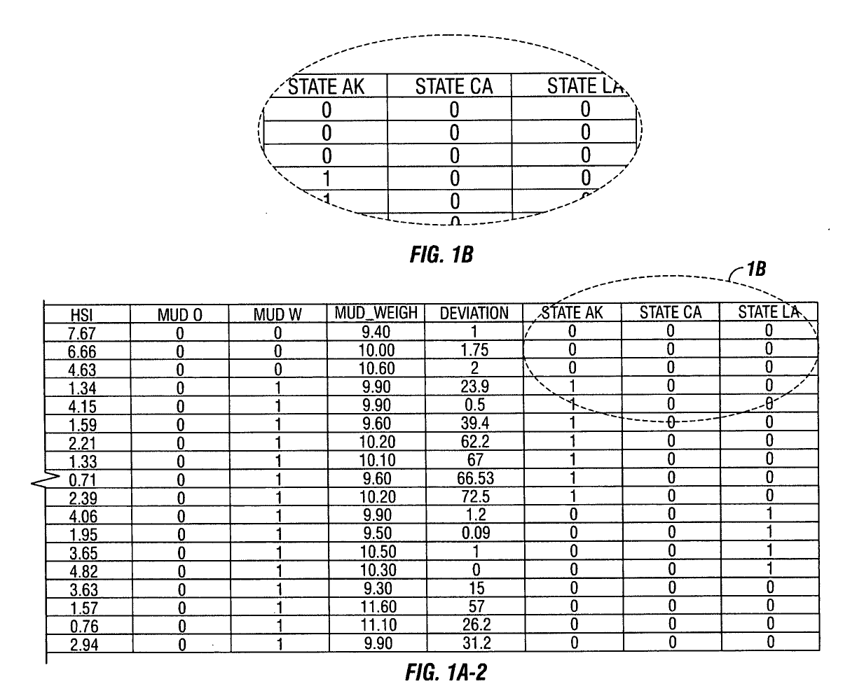

These data relating to drilling performance variables and drilling explanatory variables is typically referred to as a “bit run record.” FIG. 1 shows an example of a collection of bit run records in accordance with one or more embodiments of the present invention.

In FIG. 1, the bit run records are organized as a table having several columns and rows. Each numbered row signifies a different drilling operation and each column identifies a different variable. For example, the bit run record located in the row numbered “7” contains data for a particular drilling operation. In this particular drilling operation, a drill bit averaged, for example, a rate of penetration of 81.0 feet per hour, 195 revolutions per minute, 1,576 feet drilled, and 2.21 hydraulic horsepower per square inch. Additionally, the drill bit of this drilling operation used a type “D” rotary motor and was operated in the state of Alaska.

One of ordinary skill in the art will appreciate that non-numeric data of drilling characteristics, for example, rotary motor type, mud type, and formation type (or drilling location), can be identified using boolean values “1” (one) and “0” (zero). For example, in FIG. 1, several rows of the formation columns have been enlarged to illustrate this point. The contents of the rows of the formation columns show “0”s and “1”s. In this case, a “0” indicates that the drilling operation did not occur in that particular state, whereas a “1” indicates that the drilling operation did occur in that particular state. Similarly, “0”s and “1”s can be used to identify a rotary motor type and/or a mud type.

These bit run records may be compiled for a particular model or type of drill bit, and the data within the bit run records may be used to define relationships between the drilling performance variables and the drilling explanatory variables. Depending on the assumed relationship between dependent variables and the independent variables, namely, the drilling performance variables and the drilling explanatory variables, different models may be used to model performance of a drill bit. As previously mentioned, relating one or more dependent variables to one more independent variables may use “regression analysis.”

In accordance with embodiments of the invention, suitable regression analysis include, for example, linear regression models, polynomial regression models, logarithmic regression models, exponential regression models, and power regression models. In drilling operations, the relationship between drilling performance variables and drilling explanatory variables is typically linear and, thus, a linear regression model may be applied to a collection of bit run records. However, one of ordinary skill in the art will appreciate that different regression models may be used.

A multivariate linear regression model is generally characterized by the following equation—
y=m₁x₁+m₂x₂+. . . +mₙxₙ+b. Equation (1)

In the above-defined equation, m₁ is a variable coefficient of independent variable x₁; m₂ is a variable coefficient of independent variable x₂; and mₙ is a coefficient of independent variable xₙ. Additionally, y is a dependent variable and “b” is is a constant.

One of ordinary skill in the art will appreciate that, by using regression analysis, the variable coefficients m₁ . . . mₙ may be determined, in addition to the constant “b.” For example, using the least squares method, the sum of square deviations of data points to a fitted line is minimized. In this manner, the variable coefficients, m₁ . . . mₙ, and the constant value, “b,” are adjusted until these deviations are minimized. One of ordinary skill in the art will appreciate that other regression methods besides the sum of the least squares may be used in determining the variable coefficients and constant values of a drill bit performance model.

In addition to determining the variable coefficients, statistical methods may be used to indicate the “closeness” of fit, i.e., to provide information regarding how “well” the model fits the bit run record data. These statistical methods lend to the evaluating of the accuracy and reliability of the model.

For instance, a standard error and a coefficient contribution factor may be determined for each variable. The standard error of a variable coefficient indicates the expected fluctuation of the variable value, whereas the coefficient contribution factor indicates how the likely it is that a variable contributes to the overall function. For example, the coefficient contribution factor is useful in estimating whether an explanatory variable has an overall effect on a drilling performance variable. Generally speaking, the coefficient contribution factor is the quotient of the variable coefficient divided by the standard error. Thus, a small coefficient contribution factor indicates that the variable can fluctuate in a wide range relative to the value of the variable. Accordingly, the overall function is not sensitive to small variations in the value of this variable. In other words, a variable having a small coefficient contribution factor is an “insensitive” variable.

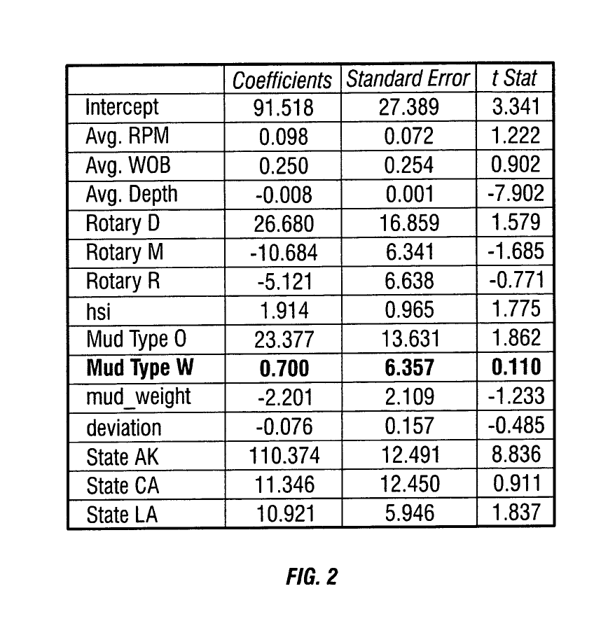

FIG. 2 shows a table of exemplary explanatory variables, which, for example, may include revolutions per minute (RPM), weight-on-bit (WOB), drilling depth, rotary motor type, hydraulic horsepower per square inch, mud type mud weight, deviation, and formation type. The associated standard errors and coefficient contribution factors for these explanatory variables are also shown in FIG. 2. In this example, the explanatory variable of revolutions per minute has a coefficient of 0.098, a standard error of 0.072, and a coefficient contribution factor of 1.422.

The usefulness of a explanatory variable may be determined by comparing the coefficient contribution factor with other coefficient contribution factors. The least useful variable is identified as the one having the smallest absolute value in its coefficient contribution factor. In this case, the mud type “W” has a value of 0.110, which has the smallest absolute value in comparison to all of the other coefficient contribution factors. Thus, for this example, the mud type “W” explanatory variable is least useful in estimating the drilling performance, such as, the rate of penetration.

Alternatively, the usefulness of a variable may be determined by comparing the coefficient contribution factor to a threshold contribution factor (i.e., some predetermined value that may be based on a statistical hypothesis test).

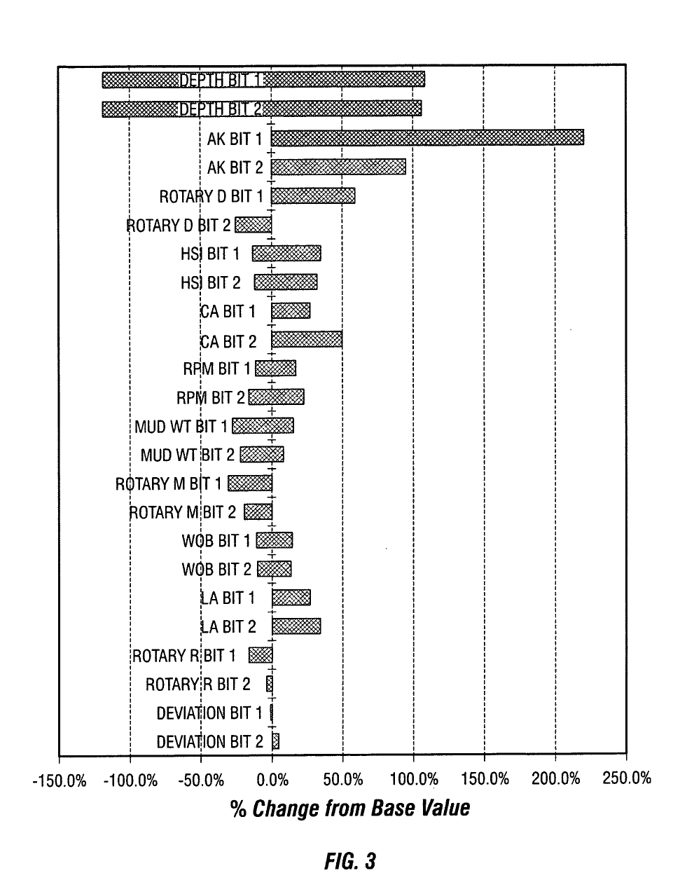

Alternatively, the usefulness of a variable may be determined by using a tornado graph, as shown in FIG. 3. In FIG. 3, the tornado graph indicates the percentage of change a particular explanatory variable has on a drilling performance variable. This percentage change from the base value can be either positive or negative in value. FIG. 3 shows that the drilling depth and the formation type and/or location contribute the most to the change of the drilling performance, whereas the deviation and rotary motor type have the least effect on the drilling performance.

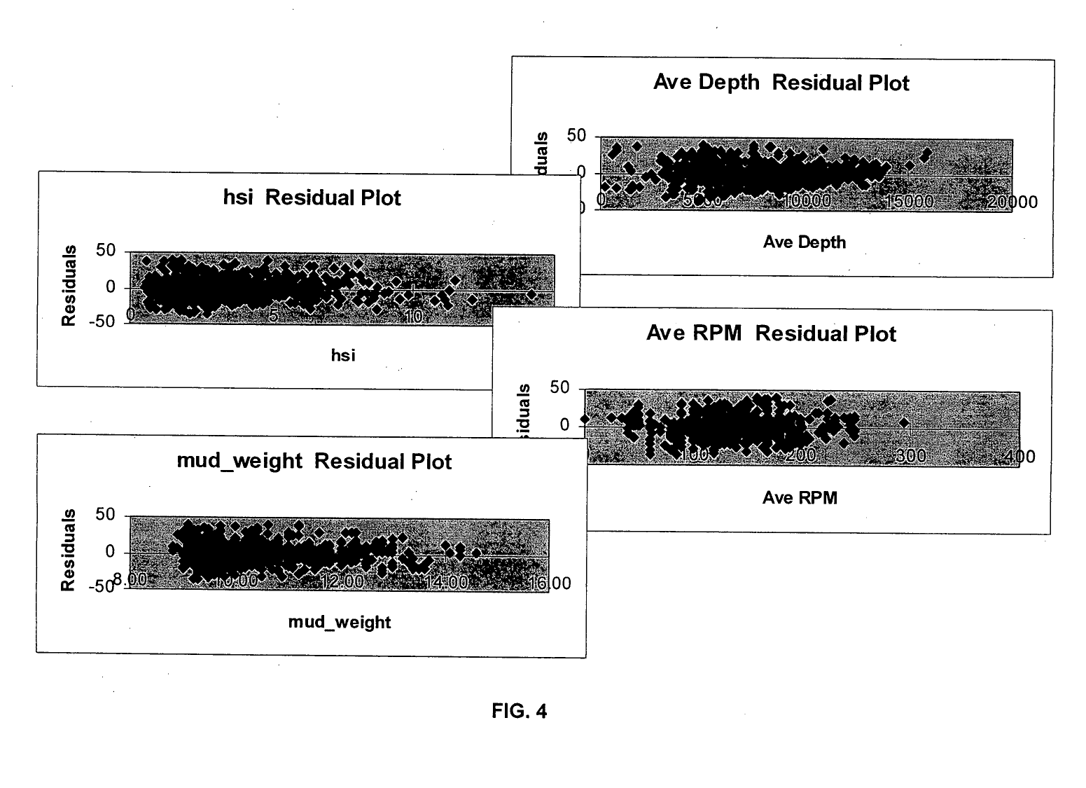

In another aspect, the reliability of the variable coefficients of the linear regression model can be determined by assessing the residuals from the regression analysis. For example, FIG. 4 shows a scatter plot of the residuals versus the explanatory variables in the model. These scatter plots or residual plots may be used to assess the sufficiency of the model. For example, if the residuals of a particular variable exhibit a systematic pattern, then the model may need improvement with respect to this explanatory variable.

Additionally, a correlation coefficient (R²) or coefficient of determination may also be used to measure how “successful” the linear regression model is in defining variation of the data. The correlation coefficient (R²) is an indicator of the closeness of fit between the drilling performance variables and the drilling explanatory variables. When the correlation coefficient (R²) is close to “1,” the linear regression model is considered to fit the data closely.

One of ordinary skill in the art will appreciate that there are a variety of statistical methods for checking the accuracy, reliability, and/or contribution of linear regression models and its variable coefficients.

Further, one of ordinary skill in the art will appreciate that software tools and suites exist that perform regression analysis on a data set, such as a table of bit records. One such tool is Microsoft® Excel®. Excel® can perform regression analysis on data stored in tabular form. Specifically, Excel® is capable of determining variable coefficients and constant values for linear regression models. Further, Excel® can generate standard errors, contribution coefficient factors (identified as “t Stat” in Excel®), in addition to residual plots, coefficients of determination (identified as “R-square” in Excel®), and tornado graphs. These software tools and suites may be implemented on virtually any type of computer system. FIG. 8 shows a typical computer system that may run software tools and suites that perform regression analysis in accordance with embodiments of the present invention, e.g., Excel®.

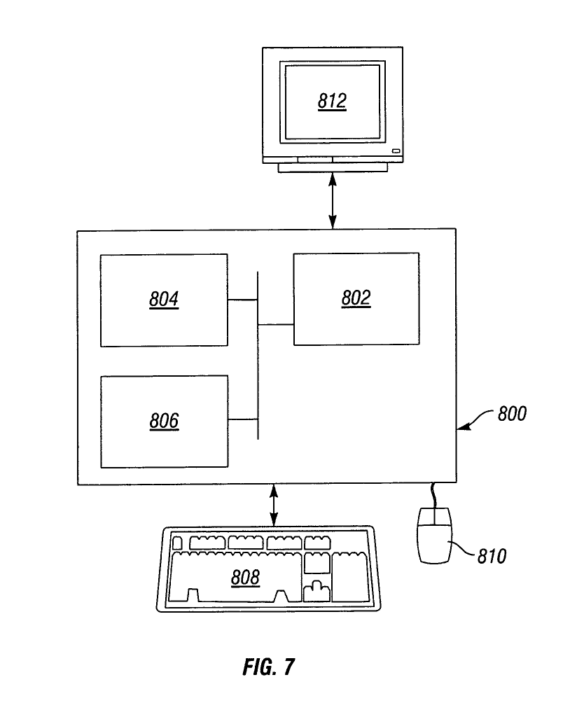

As shown in FIG. 7, a typical computer system (800) includes a processor/simulator (802), associated memory (804) a storage device (806), and numerous other elements and functionalities typical of today's computers (not shown). The computer system (800) may also include input means, such as a keyboard (808) and a mouse (810), and output means, such as a monitor (812). Those skilled in the art will appreciate that these input and output means may take other forms in an accessible environment.

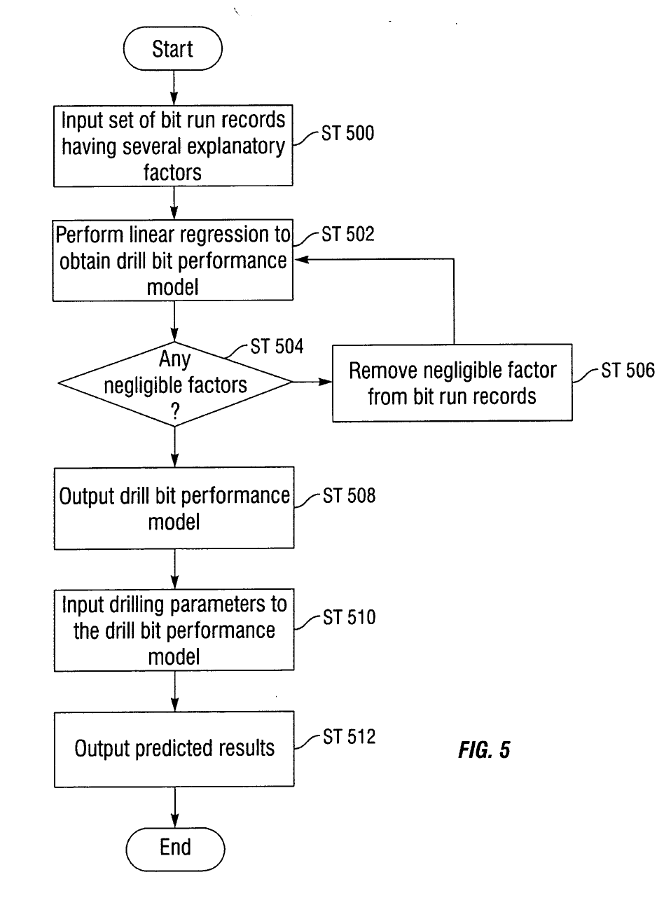

One or more embodiments of the present invention, may be used to forecast the performance of a drill bit and/or selecting a drill bit for a particular drilling operation, using regression analysis of bit run records as discussed above. FIG. 5 shows a flow chart for forecasting performance of a drill bit, in accordance with one or more embodiments of he present invention.

In FIG. 5, initially, a set of bit run records for one or more drill bits are compiled Step 500. For example, several bit run records of drilling operations, which used a particular type of drill bit, are collected in a database. Using the compiled set of bit run records, a regression algorithm is performed to obtain an initial model of the particular type of drill bit Step 502.

Once the initial model is obtained, it is evaluated to determine whether there are any negligible (or insensitive) drilling explanatory variables in the model Step 504. If there is negligible drilling explanatory variable, then the variable may be removed from the initial model Step 506 and the regression algorithm is performed again. This process may be repeated until all “insensitive” variables are removed from the initial model to produce a final model. Then, the final model is output Step 508. The drilling parameters for a prospective operation may be input to the final model Step 510 to produce predicted results from the final model and the input drilling parameters Step 512. The predicted results can be used to forecast drilling performance, (e.g., rate of penetration, a total drilling depth, and/or a time spent drilling) based on the particular drilling parameters, (e.g., weight-on-bit, deviation, revolutions per minute, etc.)

As previously mentioned, in one or more embodiments of the present invention, the drill bit performance model (both initial and final models) in FIG. 5 may be obtained by linear regression, polynomial regression, logarithmic regression, exponential regression, or power regression, etc. The regression in accordance with embodiments of the invention is a multivariate regression because multi-variable are fitted at the same time.

Step 504 in FIG. 5 may involve determining a standard error and a coefficient contribution factor for each of the variable coefficients. The variable coefficients, the standard errors, and the coefficient contribution factors can be formatted in a table, for example, as shown in FIG. 2.

After which, a determination may be made as to whether any of the coefficient contribution factors is less than a threshold contribution value. If a coefficient contribution factor is less than the threshold contribution value, then the associated drilling explanatory variable may be removed from the drill bit performance model.

Referring back to FIG. 2, assuming that the threshold contribution factor is 0.200, then the explanatory variable of mud type “W” is removed from the bit run records, because its absolute value is 0.110, which is less than 0.200 but greater than −0.200. The remaining explanatory variables in the table in FIG. 2 have coefficient contribution factors greater than 0.200, and, thus, these explanatory variables are kept in the model. The bit run records without the explanatory variable of mud type “W” are then subjected to another regression analysis to generate the following multivariate drill bit performance model—
y_{ROP}=0.06x_{RPM}+0.19x_{WOB}−0.01x_{DEP}−8.91 x_{RD}−7.07x_{RM}−1.67x_{RR}+1.21x_{HSI}−1.96x_{MUD}+0.08x_{DEV}+34.53x_{AK}+17.94x_{CA}+12.42x_{LA}+80.06. Equation (2)

In Equation 2, (which does not correspond to FIG. 2), 0.06 is a variable coefficient of the revolutions per minute explanatory variable, x_{RPM}; 0.19 is a variable coefficient of the weight-on-bit explanatory variable, x_{WOB}; −0.01 is a variable coefficient of the drilling depth explanatory variable, x_{DEP}; −8.91 is a variable coefficient of the rotary motor type “D” explanatory variable, x_{RD}; −7.07 is a variable coefficient of the rotary motor type “M” explanatory variable, x_{RM}; −1.67 is a variable coefficient of the rotary motor type “R” explanatory variable, x_{RR}; 1.21 is a variable coefficient of the hydraulic horsepower per square inch explanatory variable, x_{HSI}; 1.96 is a variable coefficient of the mud weight explanatory variable, x_{MUD}; 0.08 is a variable coefficient of the deviation explanatory variable, x_{DEV}; 34.53 is a variable coefficient of the state of Alaska explanatory variable, x_{AK}; 17.94 is a variable coefficient of the state of California explanatory variable, x_{CA}; and 12.42 is a variable coefficient of the state of Louisiana explanatory variable, x_{LA}. Additionally, y_{ROP} is a drilling performance variable, particularly, rate of penetration, which is dependent on the above-mentioned explanatory variables. Additionally, 80.06 is the constant value of the linear regression model.

Further, a the R-square value (or the coefficient of determination) of Equation 2 is 0.669, suggesting that the above model reasonably predicts the rate of penetration of the drill bit. (Note that the closer the R-square value approaches 1.00 the more accurate the model is.) Additionally, to determine the reliability of the model, residual plots of each variable coefficient may also be observed. For example, referring back to FIG. 4, the residual plot of the mud weight shows a generally funnel shape symmetric about the zero residual value, indicating that the model fits the data with respect to this explanatory variable. This test may be applied to each explanatory variable.

Once a generally accurate drill bit performance model has been obtained, a set of drilling parameters may input to Equation 2, as follows—
36.04 ft/hr=0.06(150 rpm)+0.19(25 klbs)−0.01(7000 ft)−8.91 (0)−7.07(0)−1.679(0)+1.21(4.1 hsi)−1.96(10 ppg)+0.08(0)+34.53(0)+17.94(0)+12.42(0)+80.06. Equation (3)

In Equation 3, the drilling parameters include an average revolutions per minute of 150, an average weight-on-bit of 25 klbs, an average drilling depth of 7000 feet, an average hydraulic horsepower per square inch of 4.1, and an average mud weight of 10 ppg. Given the above drilling parameters, the expected rate of penetration is 36.04 feet per hour.

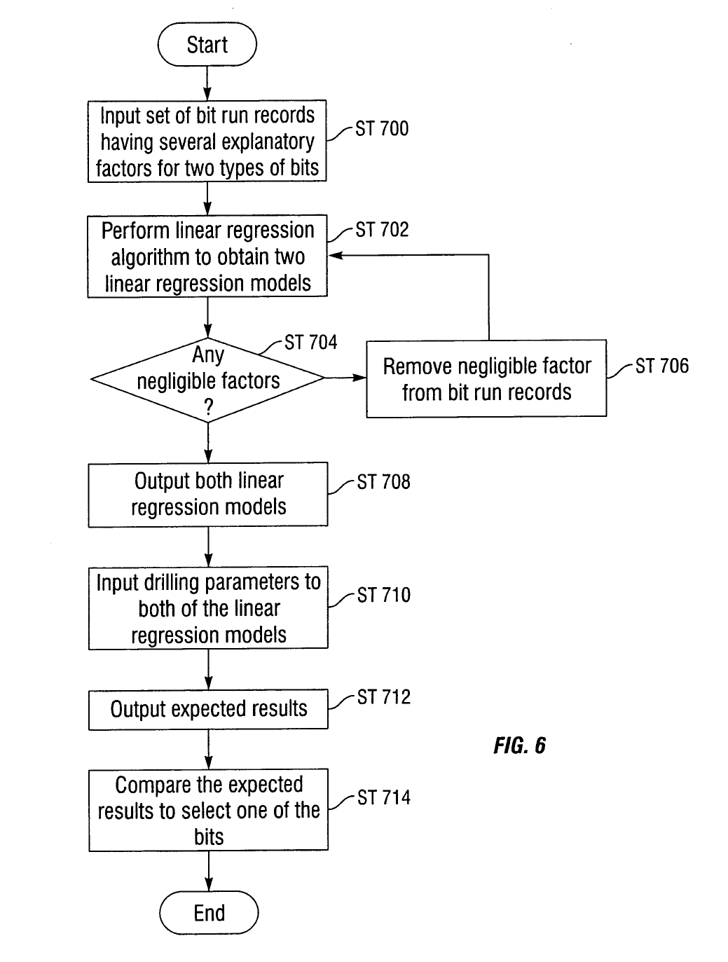

One of ordinary skill in the art will appreciate that the above method performaned on several drill bits may be used to select a drill bit most suitable for a particular drilling operation. FIG. 6 shows a flow chart for selecting a drill bit, in accordance with one or more embodiments of the present invention. Initially, at least two sets of bit run records for two different types of drill bits are compiled, respectively, Step 700. Then, a linear regression algorithm is performed on the respective bit run records to obtain two drill bit performance models Step 702. If any negligible explanatory variables exist within the respective models Step 704, these explanatory variables are removed Step 706 and the linear regression algorithm is performed again.

Once desired drill bit performance models are obtained, these models are output Step 708 The set of drilling parameters for the prospect operation may then be input to the models Step 710. The expected results of each of the models are output Step 712 and then compared, such that one of the bits can be selected for having relatively better drilling performance Step 714.

Continuing with the above example, a first drill bit performance model is obtained, as indicated in Equation 2. Additionally, a second drill bit performance model is obtained, as shown in the following equation—
−y_{ROP}=0.05x_{RPM}+0.24x_{WOB}−0.01x_{DEP}+25.21 x_{RD}+12.57x_{RM}−6.74x_{RR}+1.51x_{HSI}−2.92x_{MUD}−0.02x_{DEV}+92.85x_{AK}+11.48x_{CA}+11.02x_{LA}+102.37. Equation (4)

In Equation 4, 0.05 is a variable coefficient of the revolutions per minute explanatory variable, x_{RPM}; 0.24 is a variable coefficient of the weight-on-bit explanatory variable, x_{WOB}; −0.01 is a variable coefficient of the drilling depth explanatory variable, x_{DEP}; 25.21 is a variable coefficient of the rotary motor type “D” explanatory variable, x_{RD}; 12.57 is a variable coefficient of the rotary motor type “M” explanatory variable, x_{RM}; −6.74 is a variable coefficient of the rotary motor type “R” explanatory variable, x_{RR}; 1.51 is a variable coefficient of the hydraulic horsepower per square inch explanatory variable, x_{HSI}; −2.92 is a variable coefficient of the mud weight explanatory variable, x_{MUD}; −0.02 is a variable coefficient of the deviation explanatory variable, x_{DEV}; 92.85 is a variable coefficient of the state of Alaska explanatory variable, x_{AK}; 11.48 is a variable coefficient of the state of California explanatory variable, x_{CA}; and 11.02 is a variable coefficient of the state of Louisiana explanatory variable, x_{LA}. Additionally, y_{ROP} is a drilling performance variable, particularly, rate of penetration, which is dependent on the above-mentioned explanatory variables. Additionally, 102.37 is the constant value of the second linear regression model.

Once the performance model shown in Equation 4 is available, the same set of drilling parameters for the prospect operation may be input to Equation 4, as follows—
42.00 ft/hr=0.05(150 rpm)+0.24(25 klbs)−0.01(7000 ft)+25.21(0)+12.57(0)−6.74(0)+1.51(4.1 his)−2.92(10 ppg)−0.02(0)+92.85(0)+11.48(0)+11.02(0)+102.37. Equation (5)

In Equation 5, the same drilling parameters as in Equation 3 are input to the second drill bit performance model. Particularly, the drilling parameters include an average revolutions per minute of 150, an average weight-on-bit of 25 klbs, an average drilling depth of 7000 feet, an average hydraulic horsepower per square inch of 4.1, and an average mud weight of 10 ppg. Given the above drilling parameters, the expected rate of penetration is 42.00 feet per hour. Using both drill bit performance models, the expected rates of penetration can be calculated for particular drilling conditions and the relative performance of the drill bits may be determined. In this case, the drill bit that drilled 42.00 feet per hour outperformed the other drill bit by 5.96 feet per hour. Thus, this better performing drill bit can be selected for the given drilling conditions.

One of ordinary skill in the art will appreciate that under different drilling conditions, the respective drill bits may drill substantially differently and, thus, the drilling performance of any drill bit is dependent on the drilling conditions. Furthermore, one of ordinary skill in the art will appreciate that the comparison is generally relevant when substantially the same drilling conditions are considered. Additionally, one of ordinary skill in the art will appreciate that the above selection method may be applied to more than two models and more then two drill bits.

In one or more embodiments, advantages of the present invention include one or more of the following. The present invention leverages data that is typically collected during a drilling operation. The present invention allows all the recorded parameters to be considered in a drilling operation, i.e., both numeric and non-numeric values may be used. The present invention uses regression methods, which can account for variability of performance with respect to weight-on-bit, revolutions per minute, drilling depth, etc. The present invention uses typical computing power, when compared to forecasting and selection tools which rely on artificial neural networks or simulation systems. Because the computational costs are relatively inexpensive, the present invention is generally portable and may be used in the field by sales representatives and/or engineers in remote locations. Further, the present invention allows the regression models to be improved by using a iterative process to remove negligible factors.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for forecasting performance of a drill bit, comprising:
obtaining a performance model for the drill bit, using a plurality of bit run records of the drill bit, wherein the obtaining is performed with a multivariate regression; and
inputting a set of drilling parameters to the performance model to obtain the performance of the drill bit.

2. The method of claim 1, wherein each run record comprises at least one performance variable and at least one explanatory variable.

3. The method of claim 2, wherein the performance variable comprises at least one of a set comprising of rate of penetration, drilling hours, and drilling footage.

4. The method of claim 2, wherein the explanatory variable comprises at least one of a set comprising revolutions per minute, weight-on-bit, rotary motor type, mud weight, mud type, formation type, drilling deviation, drilling state location, and hydraulic horsepower per square inch.

5. The method of claim 2, wherein the step of obtaining the performance model comprises:
generating a preliminary model, using each explanatory variable in the plurality of run records;
determining an effect of each explanatory variable on the preliminary model; and
generating the performance model, using each of the explanatory variables having a substantial effect on the preliminary model.

6. The method of claim 2, wherein the performance model comprises a variable coefficient associated with each explanatory variable.

7. The method of claim 6, wherein the step of determining the effect of each explanatory variable comprises determining whether a coefficient contribution factor associated with each explanatory variable is less than a selected criterion, wherein the coefficient contribution factor is related to the ratio of a standard error associated with each explanatory variable over the variable coefficient.

8. The method of claim 5, wherein the step of determining the effect of each explanatory variable comprises using at least one of a tornado graph and a residual plot.

9. The method of claim 1, further comprising:
determining an accuracy of the performance model.

10. The method of claim 11, wherein determining the accuracy of the performance model is based on a coefficient of determination.

11. The method of claim 1, further comprising:
obtaining a second performance model of a second drill bit, using a set of bit run records of the second drill bit, wherein the obtaining is performed with multivariate regression;
inputting the set of drilling parameters to the second linear regression model to obtain a performance of the second drill bit;
comparing the performance of the drill bits; and
selecting one of the drill bits for the set of drilling parameters based on the comparing of the performance of the rocks bits.

12. The method of claim 1, wherein the multivariate regression comprises one of a linear regression model, a polynomial regression model, a logarithmic regression model, an exponential regression model, and a power regression model.
